(19) United States
(12) Patent Application Publication
(10) Pub. No.: US 2018/0342260 A1
(43) Pub. Date: Nov. 29, 2018

(54) Music Detection

(71) Applicant: GOVERMENT OF THE UNITED STATES AS REPRESENTED BY TE SECRETARY OF THE AIR FORCE, ROME, NY (US)

(72) Inventors: Stanley J. Wenndt, ROME, NY (US); NATHAN JONES, ROME, NY (US)

(21) Appl. No.: 15/603,502

(22) Filed: May 24, 2017

(51) Int. Cl. G10L 25/81; G10L 21/038

(52) U.S. Cl. CPC G10L 25/81; G10L 2025/783; G10H 2210/046; G10L 21/038

(57) ABSTRACT

The invention provides a method for detecting music in audio speech processing by decomposing an audio signal into component signals in one or more bandwidths. The invention then detects energy levels across preselected time and frequency windows within the narrowest bandwidth components. A predetermined number of detections at predetermined detection levels will result in the likely characterization of music being present in that window.

### STATEMENT OF GOVERNMENT INTEREST

The invention described herein may be manufactured and used by or for the Government for governmental purposes without the payment of any royalty thereon.

### BACKGROUND OF THE INVENTION

A first step in many audio processing techniques is to purify the audio stream by to detecting where speech is and is not. This is called voice activity detection which usually capitalizes on the energy of the signal and the harmonic structure of speech (or the lack of harmonic structure in noise). An additional step in voice activity detection involves detecting signals that are contaminating a speech signal, such as music. If audio signals, which are contaminated with background music, for example, are fed to an automated process, such as is language identification, the results may be degraded. Music detection is a more difficult task due to structure of music which can be similar to speech. Additionally, there is a strong variability of music genres and languages which complicate the process.

Music, regardless of the genre, typically has strong, tonal information due to the instruments and/or singing. The tonal information may be harmonics, but that is not a requirement. Human speech has tonal information, but the information is quickly changing. Tonal information in music, although it might be short, has longer duration than tonal information in human speech. The definition of music for this invention disclosure is: non-speech signals with longer tonal duration than normal speech signals. This definition of music holds true regardless of the genre, language, singing, lack of singing, quality of recording, quality of the music, signal strength of the music, types of instruments, etc. that may or may not be mixed with a speech signal. Music detection is a difficult task due to structure of music which can be similar to speech. Additionally, there is a strong variability of music genres, recording quality, and languages which complicate the process.

### OBJECTS AND SUMMARY OF THE INVENTION

It is therefore an object of the invention to optimize audio processing.

It is a further object of the invention to optimize audio processing by detecting where speech is present and where speech is not present.

It is yet a further object of the present invention to optimize audio processing by detecting signals that contaminate speech signals.

It is still a further object of the present invention to detect music as a contaminating signal in audio processing.

Briefly stated, the invention provides a method for detecting music in audio speech processing by decomposing an audio signal into component signals in one or more bandwidths. The invention then detects energy levels across preselected time and frequency windows within the narrowest bandwidth components. A predetermine number of detections at predetermined detection levels will result in the likely characterization of music being present in that window.

In an embodiment of the invention, a method for detecting music comprises decomposing a first signal into wide bandwidth components, medium bandwidth components, and narrow bandwidth components; then subtracting the wide bandwidth components from the first signal to form a second signal; then subtracting the medium bandwidth components from the second signal to form a third signal; then detecting narrow bandwidth components from the third signal and then summing the narrow bandwidth components from the third signal over a predetermined time period and predetermined frequency range; and then determining that music is present in the first signal within the predetermined time period when the summing exceeds a predetermined threshold.

The above, and other objects, features and advantages of the invention will to become apparent from the following description read in conjunction with the accompanying drawings, in which like reference numerals designate the same elements.

### BRIEF DESCRIPTION OF THE DRAWINGS

FIG. 1a depicts a signal spectrograph in amplitude versus time.

FIG. 1b depicts a signal spectrograph in frequency versus time.

FIG. 2a depicts a frequency versus time representation of the detection of narrow bandwidth components of signal decomposition as per an embodiment of the present invention.

FIG. 2b depicts an amplitude versus sample time representation of the narrow bandwidth components of signal decomposition as per an embodiment of the present invention.

FIG. 3 depicts the decomposition of an input audio signal into constituent wide bandwidth, medium bandwidth, and narrow bandwidth components as per an embodiment of the present invention.

FIG. 4 depicts the detection, summation, and subsequent decision process on the decomposed narrow bandwidth component of the input audio signal as per an embodiment of the present invention.

### DETAILED DESCRIPTION OF THE PREFERRED EMBODIMENT

The invention described herein provides a capability to detect music signals where the music signal is considered an interfering signal. The present invention does not address trying to identify the genre of music; nor does it attempt to remove or mitigate the music signal. For some applications, music may be considered an interfering signal or background noise. For other applications, music detection may provide search capabilities to locate songs of interest or genres of interest.

Most prior art approaches for music detection compute several features and feed the features to a classifier. The present invention avoids the pitfall of needing to provide music and non-music examples to train a classifier, such as a neural network. Instead, the present invention's approach defines what music is which makes this approach robust to varying recording settings, contaminating signals, and various artifacts. The goal is to develop an accurate music detection algorithm that can work in poor conditions, but can also succeed in clean recording environments.

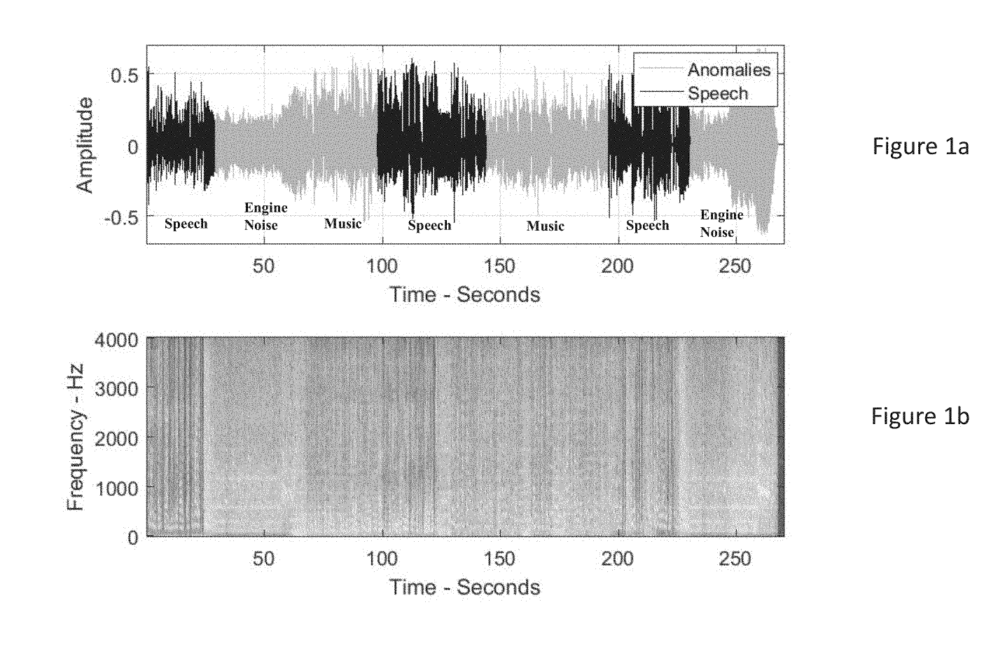

Referring to FIG. 1a and FIG. 1b depicts an example of a noisy signal where FIG. 1a is the time domain plot and FIG. 1b is the spectrogram. For this file, most of the audio is music or engine noise. The engine noise is obvious from the strong tonal information, but the music also has more tonal information compared to the speech regions. Note that even in a low signal-to-noise ratio (SNR), the tonal information becomes a key feature to identifying interfering signals.

The present invention begins the music detection process by decomposing an input signal into wide, medium, and narrow band components. The Adjustable Bandwidth Concept (ABC) (see U.S. Pat. No. 5,257,211) is one such technique that provides an automated spectral decomposition technique which requires little or no a-priori knowledge about the digital signal. By estimating an individual noise threshold for each file, the ABC algorithm finds narrowband signals that are buried in wider bandwidth, noisy signals. This helps to avoid requiring an operator to adjust multiple (and often confusing) parameters. Because no assumptions are being made as to the type of the signal, the type of noise, or the type of interference, the ABC algorithm can succeed even when there are multiple, spectrally overlapping, time coincident signals present.

Instead of looking for specific types of signals, the present invention focuses on broad classes of signal detection. For a signal, such as the spectrogram in FIG. 1a and FIG. 1b, there are multiple ways to categorize the frequency and time information. Some frequency information will be consistently present across several frequency bins, but not over time. This is referred to as wideband information. Likewise, some frequency information will be consistently present over several time bins, but not over frequency. This is referred to as narrowband information. And, in between these two definitions is medium bandwidth information that has some consistency over both time and frequency. Roughly speaking, the present invention's functionality requires the decomposition of a signal into these three types of broad classes: wide band, medium band, and narrow band frequency information.

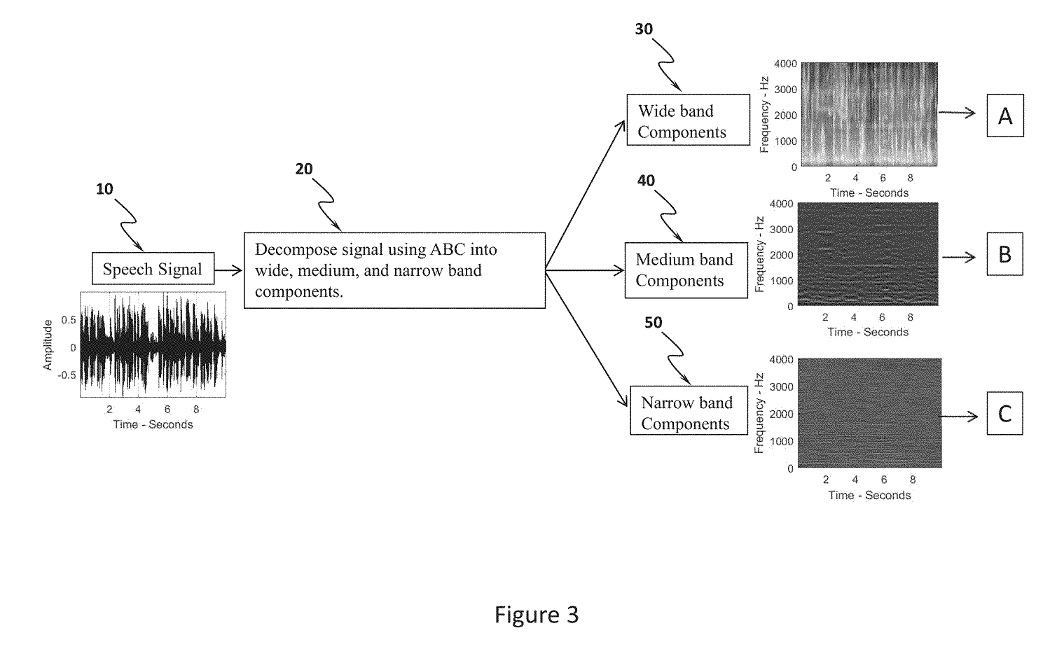

Referring to FIG. 3, the present invention's signal 10 decomposition step 20 starts by estimating the wideband information resulting in wideband information 30 and, then, subtracting off the wideband information 30 from the original signal 10. The resultant signal 40 is now composed of just medium and narrow bandwidth information. The next step is to to estimate the medium bandwidth information and then subtract off the medium band information. The resultant signal 50 now contains just the narrowband information.

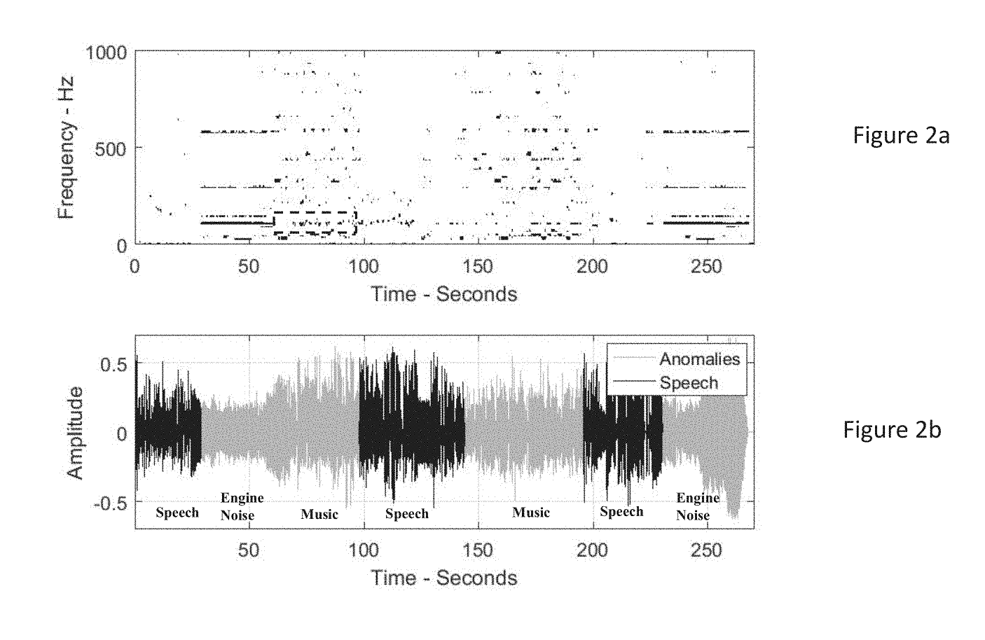

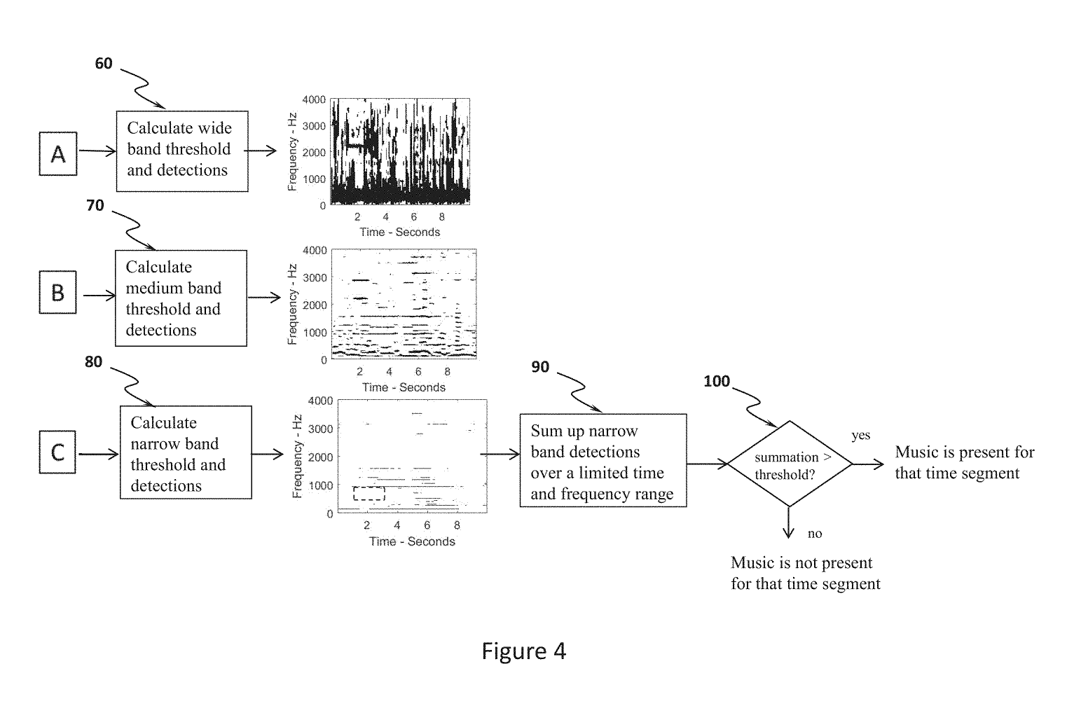

Referring to FIG. 4, each stage of wideband, medium band, and narrow band signal components is each then fed through a corresponding detection process 60, 70, and 80. Referring momentarily to FIG. 2a and FIG. 2b shows the narrowband results of using, as an example, the ABC algorithm for signal decomposition in the present invention. The narrow band detections, in FIG. 2a are binary values of ones and zeros. The dashed box 110 in FIG. 2a gives an example of a search window over which narrow band detections are sought. A ‘one’ represents a narrow band detection and is seen as a black line. A ‘zero’ is the absence of a narrow band detection and is seen as the white region.

Referring back to FIG. 4, summing up the number of detections in a limited time and frequency range 90, an empirical threshold can be developed and a determination whether the summation of the detections exceeds that threshold 100. The parameters for threshold calculation and detection 60, 70, 80 vary with the selection of search window (see FIG. 2a, 110) parameters, including the length of the search window, the lower frequency of the search window, the upper frequency of the search window, and the threshold for the number of narrow band detects in the search window.

It is within the scope of the present invention that it can be implemented in a combination of hardware and software. In certain embodiments a speech signal may already be in a digitized form, ready for immediate decomposition and downstream processing. In other embodiments the invention may comprise an audio capture means followed by analog-to-digital conversion prior to the decomposition step. It is envisioned that in all embodiments to that all functions performed by the invention can be implemented in software on a computer or alternatively software in firmware form as part of dedicated hardware embodiment of the invention.

### Results

A set of 199 files were used to validate the present invention. For strong harmonics, like rotor noise, a length parameter is introduced. If the tone is too long, then it is not counted. Likewise, low-level tones are not counted by using an energy parameter. The use of an approach like the ABC process for signal decomposition provides a simple, robust, and efficient technique to detect the presence of music in noisy, diverse files. However, it is within the scope of the present invention to utilize any other compatible signal decomposition method in lieu of the ABC process.

Adjusting the parameters (lower/upper frequency, search window length, and threshold) affect the hits, misses, and false alarms of the data. A low frequency setting might allow more noise into the search window. Depending on the parameters, more hits and more false alarms could occur. Or, depending on parameter choice, fewer hits (more misses) and fewer false alarms could occur. If fewer misses is the desired goal, then, setting a lower threshold is necessary. If fewer false alarms is the desired goal, then, setting a higher threshold is necessary. In the end, a compromise between hits, misses, and false alarms is required.

An F1 measure is meant to combine the hits, misses, and false alarms into one to number. The F1 measure is the weighted average of the precision and recall. It is scaled to be on the interval [0, 100] with its best score at 100 and its worst score at 0. The precision of the test is calculated by:

$$Precision = \frac{hits}{hits + false alarms}$$

The recall of the test is calculated by:

$$Recall = \frac{hits}{hits + misses}$$

Combining the precision and recall for the F1 measure is:

$$F 1 = 2 * \frac{Precision * Recall}{Precision + Recall} * 100.$$

The 199 files are divided into two sets of data. The first dataset is used to develop empirical thresholds for the parameters (lower/upper frequency, search window length, and threshold) while the second dataset is compute a F1 value. Then, the dataset are reversed by using the second dataset to develop the thresholds and the first dataset to compute a F1 value. The average F1 value for the 199 files using this approach is 80.75. This is still a good result since the F1 measure has three types of potential errors (hits, misses, and false alarms). Additionally, as stated previously, this is real-world data where there is a strong variety of music genres, recording quality, signal-to-noise ratio, and languages which complicate the process.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A method for detecting music, comprising
decomposing a first signal into
wide bandwidth components;
medium bandwidth components; and
narrow bandwidth components:
subtracting said wide bandwidth components from said first signal to form a second signal;
subtracting said medium bandwidth components from said second signal to form a third signal;
detecting narrow bandwidth components from said third signal;
summing said narrow bandwidth components from said third signal over a predetermined time period and predetermined frequency range; and
determining music is present in said first signal within said predetermined time period when said summing exceeds a predetermined threshold.

2. In the method of claim 1 said predetermined time period is determined by the temporal length of a search window.

3. In the method of claim 1 said predetermined frequency range is determined by an upper and a lower frequency for a search window.

4. In the method of claim 1 said predetermined threshold is determined by setting a number of narrow bandwidth detections within a search window.

5. An article of manufacture comprising a non-transitory storage medium and a plurality of programming instructions stored therein, said programming instructions being configured to program an apparatus to implement on said apparatus one or more subsystems or services, including:
decomposition of a first signal into
wide bandwidth components;
medium bandwidth components; and
narrow bandwidth components;
subtraction of said wide bandwidth components from said first signal to form a second signal;
subtraction of said medium bandwidth components from said second signal to form a third signal;
detection of narrow bandwidth components from said third signal;
summation of said narrow bandwidth components from said third signal over a predetermined time period and predetermined frequency range; and
determination that music is present in said first signal within said predetermined time period when said summing exceeds a predetermined threshold.

6. In the article of manufacture of claim 1 said predetermined time period is determined by the temporal length of a search window.

7. In the article of manufacture of claim 1 said predetermined frequency range is determined by an upper and a lower frequency for a search window.

8. In the article of manufacture of claim 1 said predetermined threshold is determined by setting a number of narrow bandwidth detections within a search window.
